(19) United States
(12) Patent Application Publication
(10) Pub. No.: US 2014/0322406 A1
(43) Pub. Date: Oct. 30, 2014

(54) SPOILAGE REDUCING COMPOSITION FOR WILD BIRD NECTAR FEEDERS

(71) Applicant: Dennis B. Jenkins, Brentwood, CA (US)

(72) Inventor: Dennis B. Jenkins, Brentwood, CA (US)

(21) Appl. No.: 13/873,232

(22) Filed: Apr. 30, 2013

(51) Int. Cl. A23K 3/00; A23K 1/18

(52) U.S. Cl. CPC A23K 3/00; A23K 1/182
USPC 426/322; 426/654

(57) ABSTRACT

There is a need to protect the health of hummingbirds by preventing the rapid microbial spoiling of sugar nectar used in hummingbird feeders, without using artificial preservatives. The invention is a method, composition and kit, for naturally preventing spoilage of sugar nectar liquid food by using a transition metal salt, an optional acidifying agent, and an optional functional additive. Certain transition metal salts, such as copper sulfate are surprisingly effective in protecting sugar nectar even at micronutrient levels, below the level consumed by hummingbirds in their natural diet. The invention prevents the formation of unhealthy microbial growth, reduces the need for frequent changing, and keeps the sugar nectar fresh and healthy.

### CROSS-REFERENCE TO RELATED APPLICATIONS

This application claims the benefit of Provisional Application 61/640,097, filed on Apr. 30, 2012, entitled “Spoilage Reducing Composition for Wild Bird Nectar Feeders”, and is incorporated by reference herein in its entirety.

### BACKGROUND OF THE INVENTION

1. Field of the Invention

The present invention relates to a method, composition and kit for preventing spoilage of sugar nectar liquid food used in hummingbird feeders, by use of a spoilage reducing composition, comprised of a transition metal salt at micronutrient concentrations, an optional acidifying agent, and an optional functional additive. The present invention also relates to methods, compositions and kits, for preventing spoilage of sugar nectar used in hummingbird feeders, by use of a spoilage reducing composition, employed as part of a ready-to-use nectar, or a dry powder or liquid concentrates mixed with water to create liquid food for hummingbirds. The present invention also relates to methods, compositions and kits, which contain a spoilage reducing composition for sugar nectar combined with a hummingbird feeder. The present invention also relates to a kit for preventing spoilage of sugar nectar for hummingbirds with instructions for combining the spoilage reducing compositions with bird feeders, liquid food and/or a plurality of liquid food. The present invention also relates to methods, compositions and kits containing transition metal salts as a safe antimicrobial treatment for the exterior or interior of any wild bird feeder.

2. Background of the Related Art

Many different types and designs of hummingbird feeders have been developed, which store and dispense liquid food or sugar nectar to birds of the family Trochilidae (U.S. Pat. No. 8,051,803, U.S. Pat. No. D602,650, U.S. Pat. No. 5,450,816). Liquid food feeders are also available for nectar drinking birds of the genus Icterus, commonly referred to as New World Orioles. The liquid food used in these feeders typically contains a mixture of sugar and water, and optionally other additives such as a colorant.

However, the liquid sugar nectar used in these feeders are all prone to developing microbial growth that can harm or kill the hummingbirds. Typically black deposits grow in the solution and on feeder parts, and the solution itself can ferment, causing harm to hummingbirds, or at the least causing them to reject the feeder.

Mold, bacteria and yeast are ubiquitous, so unless the solution is sterilized by heating, the homemade and store-purchased sugar nectar solutions are already inoculated with microbial spores. Even with these precautions, the sugar nectar still becomes inoculated with mold, bacteria and yeast when placed outside, due to exposure to the birds and other environmental contacts. These microbes multiply quickly in the sugar nectar, causing it to spoil in just a few days.

Removing mold from a hummingbird feeder is time consuming and laborious. The feeder must be emptied and rinsed trying to loosen the mold using specialized brushes. It must be bleached and rinsed several times and allowed to air dry. The sugar nectar spoils fast, so this must be done every few days, resulting in a big time commitment for maintaining a healthy feeder.

Harmful mold toxins generated by spoilage are a critical problem affecting the health of the wild birds. Some of the most toxic compounds on earth are created by molds, for example, but not limited to mycotoxins. Even trace amounts of these mycotoxins can cause harmful or lethal effects to birds.

Some commercial nectars contain a preservative, such as sodium benzoate or potassium sorbate (Patent Application US 2005/0126503) but these are artificial preservatives. These artificial preservatives are not a natural part of the hummingbird's diet and are suspected by avian experts of having harmful effects on hummingbirds. And, even when sodium benzoate or potassium sorbate are used, black mold or fermentation can still appear in the feeder in a week or two. Patent application Ser. No. 10/992,136 describes the use of artificial preservatives sodium benzoate or potassium sorbate, along with bicarbonate electrolytes to reduce dehydration in hummingbirds. Electrolytes used to reduce dehydration are metal salts selected from the alkali metal and alkali earth metal groups of the periodic table, and are not described or known to have antimicrobial effects.

What is needed is a way of preventing spoilage in sugar nectar hummingbird food that does not use artificial preservatives, but natural compounds.

Surprisingly, we have discovered that transition group metals are naturally effective in controlling microbial growth, and at the trace levels that the birds actually need as micronutrients. The use of micronutrient levels of transition metal salts to preserve nectar, is neither taught or anticipated in the prior art. And these salts are certain to be safe for birds, because they are effective at levels below the amount naturally consumed by birds.

### SUMMARY OF THE INVENTION

To protect the health of hummingbirds and make bird feeding easier for birders, there is a need to prevent the rapid spoiling of sugar nectar in hummingbird feeders. Compounds currently available are artificial, not naturally consumed by wild birds, and are suspected by experts to have negative health effects on birds. Experts recommend against the use of any artificial ingredients in nectar, especially small high-metabolism birds such as hummingbirds.

We have discovered that certain transition metals are effective at surprisingly low levels to protecting sugar nectar from microbial growth. Birds also need these metals in their diet at these micronutrient levels, to remain healthy. The concentrations needed for protecting sugar nectar are so low, that they overlap with metal micronutrient levels needed for normal metabolic function. Since these metals are naturally present in the environment and consumed by birds in their free-range diet, we have discovered a truly natural ingredient that prevents spoiling of sugar nectar in the hummingbird feeders. The invention has the added advantage of improving the health of the feeding birds due to reduction of microbial toxins in the nectar.

For example, a large part of a hummingbird's diet is small insects, and provides their main source of protein, vitamins, oils, fiber and minerals. An example are fruit flies, which are a common part of a hummingbird's diet. The copper content of a fruit fly is about 20 parts per million (ppm). Other insects commonly contain moderate levels of copper ranging from 14 to 30 ppm. Surprisingly, copper controls microbial growth in sugar nectar at micronutrient levels lower even than the copper levels in the hummingbird's natural diet of insects. Birds in general have higher copper needs than humans, and can tolerate copper at higher levels than other animals.

Copper sulfate is known to control algae in ponds and lakes, but is not taught or anticipated to generally control microbials in bird food, particularly for hummingbird sugar nectar, and particularly at trace micronutrient levels.

The present invention relates to a spoilage preventing method, spoilage reducing composition and kit for preventing the spoilage and molding problems of liquid food sugar nectar used in wild hummingbird feeders or wild oriole feeders.

The present invention, in its embodiments as a spoilage reducing composition, method and kit, has the added advantage of improving the health of the feeding birds due to reduction of microbial toxins in the nectar.

In the spoilage reducing compositions of the present invention, the transition metal salt serves in the capacity to hinder the growth of microbes, thus prolonging sugar nectar freshness and reducing sugar nectar spoilage in wild bird nectar feeders. The acidifying agent serves to keep the transition metal cation in a more chemically free state, available for reaction. The acidifying agent may also play a role in enhancing the ability of the transition metal cation to produce free oxygen, an important component for antimicrobial action.

One embodiment of the present invention is a method employing a spoilage reducing composition that is combined with sugar nectar and a wild bird nectar feeder. The spoilage reducing compositions of the present invention comprises an effective amount of transition metal salt, optionally an acidifying agent, optionally a functional additive, and optionally further adjuncts.

One embodiment of the present invention is a method for preventing spoilage of sugar nectar in a nectar feeder wherein the spoilage reducing composition comprises an effective amount of certain metal salts from the d-block elements of the periodic table, commonly referred to as transition metals.

One embodiment of the present invention is a method for preventing spoilage of sugar nectar in a wild bird nectar feeder wherein the transition metal salt of the spoilage reducing composition comprises a transition metal salt selected from the group consisting of a copper salt, a zinc salt, an iron salt, a nickel salt, a cobalt salt, a molybdenum salt, a chromium salt, a manganese salt, a silver salt and mixtures thereof.

One embodiment of the present invention is a method for preventing spoilage of sugar nectar in a wild bird nectar feeder wherein the transition metal salt of the spoilage reducing composition comprises a metal chelate, such as a metal EDTA.

One embodiment of the present invention is a method for preventing spoilage of sugar nectar in a wild bird nectar feeder wherein the transition metal salt of the spoilage reducing composition comprises a copper (II) sulfate.

One embodiment of the present invention is a method for preventing spoilage of sugar nectar in a wild bird nectar feeder wherein the transition metal salt of the spoilage reducing composition comprises a copper salt selected from the group consisting of copper chloride, copper nitrate, copper citrate, copper acetate, copper oleate, copper carbonate, copper sulfate, copper hydroxide, copper sulfide, copper oxide, copper phosphate, copper gluconate, copper borate and mixtures thereof.

One embodiment of the present invention is a method for preventing spoilage of sugar nectar in a wild bird nectar feeder wherein the transition metal salt of the spoilage reducing composition comprises a copper mineral selected from the group consisting of azurite, malachite, bornite, cuprite, chalcopyrite, chalcocite, chrysocolla, and mixtures thereof.

One embodiment of the present invention is a method for preventing spoilage of sugar nectar in a wild bird nectar feeder wherein the transition metal salt of the spoilage reducing composition comprises a zinc salt.

One embodiment of the present invention is a method for preventing spoilage of sugar nectar in a wild bird nectar feeder wherein the transition metal salt of the spoilage reducing composition comprises a zinc salt selected from the group consisting of zinc chloride, zinc nitrate, zinc citrate, zinc acetate, zinc carbonate, zinc sulfate, zinc hydroxide, zinc sulfide, zinc oxide, zinc phosphate, zinc borate, zinc gluconate, and mixtures thereof.

One embodiment of the present invention is a method for preventing spoilage of sugar nectar in a wild bird nectar feeder wherein the transition metal salt of the spoilage reducing composition comprises a zinc mineral selected from the group consisting of smithsonite, sphalerite, wurtzite, hydrozincite, and mixtures thereof.

One embodiment of the present invention is a method for preventing spoilage of sugar nectar in a wild bird nectar feeder wherein the transition metal salt of the spoilage reducing composition is a nanomaterial comprised of a transition metal, transition metal salt, combination of transition metals, or combination of transition metal salts.

One embodiment of the present invention is a method for preventing spoilage of sugar nectar in a wild bird nectar feeder wherein the transition metal salt of the spoilage reducing composition is created by combining a native transition metal and an acidifying agent.

One embodiment of the present invention is a method for preventing spoilage of sugar nectar in a wild bird nectar feeder wherein the acidifying agent of the spoilage reducing composition is selected from the group consisting of citric acid, lactic acid, fumaric acid, ascorbic acid, carbonic acid, phosphoric acid, acetic acid, boric acid, oxalic acid, tartaric acid, and mixtures thereof.

One embodiment of the present invention is a method for preventing spoilage of sugar nectar in a wild bird nectar feeder wherein the spoilage reducing composition comprises copper sulfate as the transition metal salt, and citric acid as the acidifying agent.

One embodiment of the present invention is a method for preventing spoilage of sugar nectar in a wild bird nectar feeder wherein the functional additive of the spoilage reducing composition is selected from the group consisting of colorants, vitamins, spoilage indicators, anti-microbial agents, anti-molding agents, odor absorbers, flavorants, anti-caking agents, fragrances, and mixtures thereof.

One embodiment of the present invention is a method for treating the exterior or interior of any type of wild bird feeder with an antimicrobial solution, which comprises an effective amount of transition metal salt, optionally an acidifying agent, optionally a functional additive, and optionally further adjuncts.

One embodiment of the present invention is a method for treating the exterior or interior of any type of wild bird feeder with an antimicrobial solution, wherein the transition metal salt solution is packaged in a spray bottle, and used to spray the exterior or interior of any type of wild bird feeder.

In one embodiment of the present invention, a spoilage reducing composition containing a transition metal salt is used as an additive to sugar nectar. The invention further provides for the addition of a spoilage reducing composition to a wild bird nectar feeder a) when the feeder is empty before adding sugar nectar (for example at the bottom of the feeder), b) simultaneously as the sugar nectar is being added to the feeder (blended with or added with the sugar nectar during addition to the feeder), and/or c) after the sugar nectar has added to the feeder (for example, on top of the sugar nectar), and any combinations of the thereof. The spoilage reducing compositions of the present invention are effective when used at the top and/or bottom of the feeder, and also when combined with the sugar nectar.

In one embodiment of the present invention, the spoilage reducing composition comprises an effective amount of certain metal salts from the d-block elements of the periodic table, commonly referred to as transition metals.

In one embodiment of the present invention, a spoilage reducing composition comprises an effective amount of transition metal salt, optionally an acidifying agent, optionally a functional additive, and optionally further adjuncts.

In one embodiment of the present invention, the transition metal salt of the spoilage reducing composition comprises a transition metal salt selected from the group consisting of a copper salt, a zinc salt, an iron salt, a nickel salt, a cobalt salt, a molybdenum salt, a chromium salt, a manganese salt, a silver salt and mixtures thereof.

In one embodiment of the present invention, the transition metal salt of the spoilage reducing composition comprises a metal chelate, such as a metal EDTA.

In one embodiment of the present invention, the transition metal salt of the spoilage reducing composition comprises a copper salt selected from the group consisting of copper chloride, copper nitrate, copper citrate, copper acetate, copper oleate, copper carbonate, copper sulfate, copper hydroxide, copper sulfide, copper oxide, copper phosphate, copper gluconate, copper borate and mixtures thereof.

In one embodiment of the present invention, the transition metal salt of the spoilage reducing composition comprises a copper mineral selected from the group consisting of azurite, malachite, bornite, cuprite, chalcopyrite, chalcocite, chrysocolla, and mixtures thereof.

In one embodiment of the present invention, the transition metal salt of the spoilage reducing composition comprises a copper (II) sulfate.

In one embodiment of the present invention, the transition metal salt of the spoilage reducing composition comprises a zinc salt.

In one embodiment of the present invention, the transition metal salt of the spoilage reducing composition comprises a zinc salt selected from the group consisting of zinc chloride, zinc nitrate, zinc citrate, zinc acetate, zinc carbonate, zinc sulfate, zinc hydroxide, zinc sulfide, zinc oxide, zinc phosphate, zinc borate, zinc gluconate, and mixtures thereof.

In one embodiment of the present invention, the transition metal salt of the spoilage reducing composition comprises a zinc mineral selected from the group consisting of smithsonite, sphalerite, wurtzite, hydrozincite, and mixtures thereof.

In one embodiment of the present invention, the transition metal salt of the spoilage reducing composition is a nanomaterial comprised of a transition metal, transition metal salt, combination of transition metals, or combination of transition metal salts.

In one embodiment of the present invention, the transition metal salt of the spoilage reducing composition is created by combining a native transition metal and an acidifying agent.

In one embodiment of the present invention, the acidifying agent of the spoilage reducing composition is selected from the group consisting of citric acid, lactic acid, fumaric acid, ascorbic acid, carbonic acid, phosphoric acid, acetic acid, boric acid, oxalic acid, tartaric acid, and mixtures thereof.

In one embodiment of the present invention, the spoilage reducing composition comprises copper sulfate as the transition metal salt, and citric acid as the acidifying agent.

In one embodiment of the present invention, the functional additive of the spoilage reducing composition is selected from the group consisting of colorants, vitamins, spoilage indicators, anti-microbial agents, anti-molding agents, odor absorbers, flavorants, anti-caking agents, fragrances, and mixtures thereof.

In one embodiment of the present invention, the spoilage reducing composition occurs in packets or containers to be mixed with sugar nectar and poured into the wild bird nectar feeder.

In one embodiment of the present invention, the spoilage reducing composition occurs in packets or containers to be poured into the wild bird nectar feeder before or after the sugar nectar.

In one embodiment of the present invention, the spoilage reducing composition occurs combined with a powdered sugar nectar to be mixed with water and added to the wild bird nectar feeder.

In one embodiment of the present invention, the spoilage reducing composition occurs as a powder or concentrate to be poured into the wild bird nectar feeder before or after the sugar nectar

In one embodiment of the present invention, the spoilage reducing composition occurs pre-mixed with the liquid food to be poured directly into the wild bird nectar feeder.

In one embodiment of the present invention, the spoilage reducing composition occurs in a shaped body placed in the wild bird nectar feeder, wherein said shaped body comprises a form selected from the group consisting of a powder, granule, crystal, solid, gel, foam, disk, cube, cylinder, rod, ovoid, torus, sphere, donut, pyramid, prism, and combinations thereof.

In one embodiment of the present invention, a solution containing an effective amount of transition metal salt, optionally an acidifying agent, optionally a functional additive, and optionally further adjuncts, is used as an antimicrobial solution, for treating the exterior or interior of any type of wild bird feeder to inhibit antimicrobial growth.

In one embodiment of the present invention, the antimicrobial transition metal salt solution composition is packaged in a spray bottle, for spraying and treating the exterior or interior of any type of wild bird feeder to inhibit antimicrobial growth.

In one embodiment of the present invention, the resulting transition metal salt of the spoilage reducing composition is between about 2 parts per million to 20 parts per million of the weight of the bird sugar nectar present in the feeder.

In one embodiment of the present invention, the resulting transition metal salt of the spoilage reducing composition is between about 0.1 part per million to 200 parts per million of the weight of the bird sugar nectar present in the feeder.

In one embodiment of the present invention, the resulting acidifying agent of the spoilage reducing composition is between about 0.01% to 5% of the weight of the bird sugar nectar present in the feeder.

One embodiment of the present invention provides a kit for preventing spoilage of bird sugar nectar in a bird nectar feeder.

One embodiment of the present invention provides a kit comprising i) a spoilage reducing composition comprising an effective amount of transition metal salt and ii) instructions for combining the spoilage reducing composition with sugar nectar.

One embodiment of the present invention provides a kit comprising: (i) a spoilage reducing composition comprising: (a) an effective amount of transition metal salt and (b) a acidifying agent; and (ii) instructions for combining the spoilage reducing composition with sugar nectar.

One embodiment of the present invention provides a kit comprising: (i) a spoilage reducing composition comprising: (a) an effective amount of transition metal salt; and (b) a functional additive; and (ii) instructions for combining the spoilage reducing composition with sugar nectar.

One embodiment of the present invention provides a kit comprising: (i) a spoilage reducing composition comprising: (a) an effective amount of transition metal salt; (b) an acidifying agent; and (c) a functional additive; and (ii) instructions for combining the spoilage reducing composition with sugar nectar.

One embodiment of the present invention provides a kit comprising: (i) a spoilage reducing composition comprising an effective amount of transition metal salt; (ii) sugar nectar; and (iii) instructions for combining with water and placing into a sugar nectar feeder.

One embodiment of the present invention provides a kit comprising: (i) a spoilage reducing composition comprising: (a) an effective amount of transition metal salt; and (b) an acidifying agent; (ii) sugar nectar; and (iii) instructions for combining with water and placing into a sugar nectar feeder.

One embodiment of the present invention provides a kit comprising: (i) a spoilage reducing composition comprising: (a) an effective amount of transition metal salt; and (b) a functional additive; (ii) sugar nectar; and (iii) instructions for combining with water and placing into a sugar nectar feeder.

One embodiment of the present invention provides a kit comprising: (i) a spoilage reducing composition comprising: (a) an effective amount of transition metal salt; (b) an acidifying agent; and (c) a functional additive; (ii) sugar nectar; and (iii) instructions for combining with water and placing into a sugar nectar feeder.

One embodiment of the present invention provides a kit for preventing spoilage of sugar nectar in a wild bird nectar feeder, wherein the sugar nectar comprises a mixture of water and saccharides.

One embodiment of the present invention is a kit for preventing spoilage of sugar nectar in a wild bird nectar feeder wherein the transition metal salt of the spoilage reducing composition comprises an effective amount of certain metal salts from the d-block elements of the periodic table, commonly referred to as transition metals.

One embodiment of the present invention is a kit for preventing spoilage of sugar nectar in a wild bird nectar feeder wherein the transition metal salt of the spoilage reducing composition comprises a transition metal salt selected from the group consisting of a copper salt, a zinc salt, an iron salt, a nickel salt, a cobalt salt, a molybdenum salt, a chromium salt, a manganese salt, a silver salt and mixtures thereof.

One embodiment of the present invention is a kit for preventing spoilage of sugar nectar in a wild bird nectar feeder wherein the transition metal salt of the spoilage reducing composition comprises a metal chelate, such as a metal EDTA.

One embodiment of the present invention is a kit for preventing spoilage of sugar nectar in a wild bird nectar feeder wherein the transition metal salt of the spoilage reducing composition comprises a copper salt selected from the group consisting of copper chloride, copper nitrate, copper citrate, copper acetate, copper oleate, copper carbonate, copper sulfate, copper hydroxide, copper sulfide, copper oxide, copper phosphate, copper gluconate, copper borate and mixtures thereof.

One embodiment of the present invention is a kit for preventing spoilage of sugar nectar in a wild bird nectar feeder wherein the transition metal salt of the spoilage reducing composition comprises a copper mineral selected from the group consisting of azurite, malachite, bornite, cuprite, chalcopyrite, chalcocite, chrysocolla, and mixtures thereof.

One embodiment of the present invention is a kit for preventing spoilage of sugar nectar in a wild bird nectar feeder wherein the transition metal salt of the spoilage reducing composition comprises a copper (II) sulfate.

One embodiment of the present invention is a kit for preventing spoilage of sugar nectar in a wild bird nectar feeder wherein the transition metal salt of the spoilage reducing composition comprises a zinc salt.

One embodiment of the present invention is a kit for preventing spoilage of sugar nectar in a wild bird nectar feeder wherein the transition metal salt of the spoilage reducing composition comprises a zinc salt selected from the group consisting of zinc chloride, zinc nitrate, zinc citrate, zinc acetate, zinc carbonate, zinc sulfate, zinc hydroxide, zinc sulfide, zinc oxide, zinc phosphate, zinc borate, zinc gluconate, and mixtures thereof.

One embodiment of the present invention is a kit for preventing spoilage of sugar nectar in a wild bird nectar feeder wherein the transition metal salt of the spoilage reducing composition comprises a zinc mineral selected from the group consisting of smithsonite, sphalerite, wurtzite, hydrozincite, and mixtures thereof.

One embodiment of the present invention is a kit for preventing spoilage of sugar nectar in a wild bird nectar feeder wherein the transition metal salt of the spoilage reducing composition is a nanomaterial comprised of a transition metal, transition metal salt, combination of transition metals, or combination of transition metal salts.

One embodiment of the present invention is a kit for preventing spoilage of sugar nectar in a wild bird nectar feeder wherein the transition metal salt of created by combining a native transition metal and an acidifying agent.

One embodiment of the present invention is a kit for preventing spoilage of sugar nectar in a wild bird nectar feeder wherein the acidifying agent of the spoilage reducing composition is selected from the group consisting of citric acid, lactic acid, fumaric acid, ascorbic acid, carbonic acid, phosphoric acid, acetic acid, boric acid, oxalic acid, tartaric acid, and mixtures thereof.

One embodiment of the present invention is a kit for preventing spoilage of sugar nectar in a wild bird nectar feeder wherein the spoilage reducing composition comprises copper sulfate as the transition metal salt, and citric acid as the acidifying agent.

One embodiment of the present invention is a kit for preventing spoilage of sugar nectar in a wild bird nectar feeder wherein the functional additive of the spoilage reducing composition is selected from the group consisting of colorants, vitamins, spoilage indicators, anti-microbial agents, anti-molding agents, odor absorbers, flavorants, anti-caking agents, fragrances, and mixtures thereof.

One embodiment of the present invention is a kit for preventing spoilage of sugar nectar in a wild bird nectar feeder wherein the spoilage reducing composition occurs in packets or containers to be poured into the wild bird nectar feeder before or after the sugar nectar.

One embodiment of the present invention is a kit for preventing spoilage of sugar nectar in a wild bird nectar feeder wherein the spoilage reducing composition occurs in packets or containers to be mixed with sugar nectar and poured into the wild bird nectar feeder.

One embodiment of the present invention is a kit for preventing spoilage of sugar nectar in a wild bird nectar feeder wherein the spoilage reducing composition occurs as a powder or concentrate to be poured into the wild bird nectar feeder before or after the sugar nectar

One embodiment of the present invention is a kit for preventing spoilage of sugar nectar in a wild bird nectar feeder wherein the spoilage reducing composition occurs as a powder or concentrate to be mixed with sugar nectar and poured into the wild bird nectar feeder.

One embodiment of the present invention is a kit for preventing spoilage of sugar nectar in a wild bird nectar feeder wherein the spoilage reducing composition occurs pre-mixed with the sugar nectar, ready to be poured directly into the nectar feeder.

One embodiment of the present invention is a kit for preventing spoilage of sugar nectar in a wild bird nectar feeder wherein the instructions comprise the step of adding said spoilage reducing composition to said feeder in an effective amount prior to addition of said sugar nectar.

One embodiment of the present invention is a kit for preventing spoilage of sugar nectar in a wild bird nectar feeder wherein the instructions comprise the step of adding said spoilage reducing composition simultaneously with said sugar nectar to said feeder.

One embodiment of the present invention is a kit for preventing spoilage of sugar nectar in a wild bird nectar feeder wherein the instructions comprise the step of adding said spoiling reducing composition to said feeder in an effective amount following addition of said sugar nectar.

One embodiment of the present invention is a kit for preventing spoilage of sugar nectar in a wild bird nectar feeder wherein the instructions comprise the step of mixing said spoilage reducing composition with sugar nectar prior to addition to the wild bird nectar feeder.

One embodiment of the present invention is a kit for preventing spoilage of sugar nectar in a wild bird nectar feeder wherein the instructions comprise any combination of the steps selected from the group consisting of (1) adding said spoilage reducing composition to said feeder in an effective amount prior to addition of said sugar nectar, (2) adding said spoilage reducing composition simultaneously with said sugar nectar to said feeder, (3) adding said spoiling reducing composition to said feeder in an effective amount following addition of said sugar nectar, (4), mixing said spoilage reducing composition with sugar nectar prior to addition to wild bird nectar feeder.

One embodiment of the present invention is a kit for preventing spoilage of sugar nectar in a wild bird nectar feeder wherein the effective amount of the spoilage reducing composition is between about 2 parts per million to 20 parts per million of the weight of the bird sugar nectar present in the feeder.

One embodiment of the present invention is a kit for preventing spoilage of sugar nectar in a wild bird nectar feeder wherein the effective amount of the spoilage reducing composition is between about 0.1 parts per million to 200 parts per million of the weight of the bird sugar nectar present in the feeder.

One embodiment of the present invention is a kit for preventing spoilage of sugar nectar in a wild bird nectar feeder wherein the spoilage reducing composition occurs as a shaped body, in the shape of a rod, tube, granule, crystal, gel, foam, disk, torus, cylinder, cube, prism, pyramid, disk, donut, ovoid, and combinations thereof, to be placed in the feeder along with the sugar nectar.

One embodiment of the present invention is a kit for preventing spoilage of sugar nectar in a wild bird nectar feeder wherein the acidifying agent of the spoilage reducing composition is between about 0.01% to 5% of the weight of the bird sugar nectar present in the feeder.

One embodiment of the present invention is a kit for treating the exterior or interior of any type of wild bird feeder with an effective amount of transition metal salt solution, optionally an acidifying agent, optionally a functional additive, and instructions.

One embodiment of the present invention is a kit for treating the exterior or interior of any type of wild bird feeder with a transition metal salt solution, packaged in a spray bottle with instructions, and used to spray the exterior or interior of any type of wild bird feeder.

### DETAILED DESCRIPTION

Before describing the present invention in detail, it is to be understood that this invention is not limited to particularly exemplified formulas or ingredients as such may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “indicating agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### Sugar Nectar

Sugar Nectar compositions can include any mixture of liquid or dry saccharides commonly ingested by wild, domestic, or agricultural birds. Those practiced in the art recognize that this generally means solutions or powders containing sucrose, but can also contain other sugars such as fructose, glucose, simple sugars, complex sugars, or other ingredients such as dextrin, starch, salts, minerals and mixtures thereof.

Many birders prepare their own sugar nectars by combining water and granulated sucrose. These are commonly prepared in a water:sucrose ratio of 4:1 by volume, but can range from ratios of 5:1 to 2:1.

Sugar nectars are available commercially pre-made, and often contain dyes, and artificial preservatives.

Sugar nectars are also commercially sold as liquid concentrates ranging from 50% sucrose to 70% sucrose, and powdered concentrates that are nearly 100% sucrose. Pre-made commercial nectars comprised of a sugar and water mixture that can range from a sucrose content of 15% to 25% sugar by weight. Generally the sugar is in the form of sucrose, commonly cane sugar sucrose, but can also contain other sugars such as fructose or glucose.

### Nectar Feeder

A nectar feeder is a device designed to dispense or display liquid food for the purpose of giving access of the food to birds. Examples of which are inverted feeders and saucer feeders. An inverted feeder has a central reservoir that is suspended over the feeding ports and releases nectar from above. The effects of vacuum keep the nectar from flowing freely out the ports, keeping the ports filled at optimum levels. Inverted feeders can be top filling or bottom filling style. A saucer feeder is a simple dish filled with nectar that has ports above the reservoir, allowing birds to dip their bills into the nectar supply. A nectar feeder can be as simple as an inverted glass bottle with a tube at the bottom, or as complicated as a multiple feeding-port feeder with insect-resistant barriers. They all have in common a reservoir to hold the nectar, and feeding ports which restrict the free flow of the nectar out of the feeder while providing nectar access to the hummingbirds.

### Spoilage Reducing Compositions

The spoilage reducing compositions of the present invention comprise: (a) an effective amount of a transition metal salt; (b) optionally, an acidifying agent; (c) optionally, a functional additive; and (d) optional adjuncts. The spoilage reducing compositions may also be in shaped form, such as a geometric shape, which may be placed into the feeder.

The spoilage reducing composition can occur with the sugar nectar, or can occur in packets or containers, as a powder or liquid concentrate. It can also occur premixed with sugar nectar.

An effective amount of the spoilage reducing composition is that amount of material, or greater, that is needed to have any noticeable effect on the reduction of microbial growth in a nectar feeder. Testing shows that 2 ppm weight percent or less of the spoilage reducing composition can have significant effects on the reduction of spoilage, and it is anticipated that the minimum effective level is much less than that amount.

The spoilage reducing composition can also be used as an antimicrobial solution for treating the exterior or interior of any type of wild bird feeder.

### Transition Metal Salt

In the spoilage reducing compositions of the present invention, the transition metal salt serves in the capacity to hinder the growth of microbes, thus prolonging sugar nectar freshness and reducing sugar nectar spoilage in wild bird nectar feeders. Many of the transition metal salts react with water to create oxygen, thought to be effective in inhibiting the growth of microbes.

The spoilage reducing composition should result in a level of transition metal salt in the feeder, that is below the level that would harm nectar feeding birds, and preferably be in the micronutrient range.

Transition metal salts are compounds comprised of a metal cation from the d-block elements of the periodic table and an anion. Transition metal cations include copper, zinc, manganese, iron, and silver. Transition metal cations can be in several different valance states.

The transition metal salt could be selected from the group consisting of a copper salt, a zinc salt, an iron salt, a nickel salt, a cobalt salt, a molybdenum salt, a chromium salt, a manganese salt, a silver salt and mixtures thereof.

The transition metal salt can contain copper cations such as in copper sulfate.

The transition metal salt can be copper salt in any one of several valance states such as a copper(II) salt, a copper(I) salt and mixtures thereof.

The transition metal salt can contain any anion combined with copper, such as copper chloride, copper nitrate, copper citrate, copper acetate, copper carbonate, copper sulfate, copper hydroxide, copper sulfide, copper oxide, copper phosphate, copper borate, copper gluconate and mixtures thereof.

The transition metal salt can be a mineral ore of copper, such as azurite, malachite, bornite, cuprite, chalcopyrite, chalcocite, chrysocolla, and mixtures thereof.

The transition metal salt can contain zinc cations such as in zinc gluconate.

The transition metal salt can contain any anion combined with zinc, such as zinc chloride, zinc nitrate, zinc citrate, zinc acetate, zinc carbonate, zinc sulfate, zinc hydroxide, zinc sulfide, zinc oxide, zinc phosphate, zinc borate, zinc gluconate, and mixtures thereof.

The transition metal salt can be a mineral ore of zinc, such smithsonite, sphalerite, wurtzite, hydrozincite, and mixtures thereof.

The transition metal salt can contain silver metal cations such as in silver nitrate.

The transition metal of the transition metal salt can be in any one of several valance states.

The transition metal of the transition metal salt can be a nanomaterial comprised of a transition transition metal salt, or combination of transition metal salts.

The transition metal of the transition metal salt can be a transition metal, or nanosized transition metal that creates a salt when added to the sugar nectar.

The transition metal salt can contain any anion combined with the transition metal cation such as a metal chloride, metal nitrate, metal citrate, metal acetate, metal carbonate, metal sulfate, metal hydroxide, metal sulfide, metal oxide, metal phosphate, metal borate, metal gluconate and mixtures thereof.

The transition metal salt can be a mineral ore of a transition metal, such as a mineral metal carbonate, mineral metal sulfate, mineral metal hydroxide, mineral metal sulfide, mineral metal oxide, mineral metal silicate, mineral metal borate, mineral metal phosphate, mineral metal chloride, and mixtures thereof.

### Acidifying Agent

An acidifying agent is any compound that decreases the pH of the sugar nectar. Acidifying agents include citric acid, lactic acid, fumaric acid, ascorbic acid, carbonic acid, phosphoric acid, acetic acid, boric acid, hydrochloric acid, sulfuric acid, oxalic acid, and tartaric acid. Acidifying agents can be included in solid or liquid in form. The acidifying agent serves to keep the transition metal cation in a more chemically free state, available for reaction. The acidifying agent may also play a role in enhancing the ability of the transition metal cation to produce free oxygen, an important component for antimicrobial action.

### Functional Materials

Functional materials that may further be combined with the present inventive compositions include coloring agents, anti-caking agents and binding agents. Additional functional materials include, but are not limited to vitamins, anti-microbial agents, anti-molding agents, odor absorbers, spoilage indicators, flavorants, and fragrance. The functional materials may be present in any desirable weight percent with respect to the spoilage reducing composition. In general, the functional materials are generally employed at an effective level, such level being sufficient with respect to the spoilage reducing composition, to adequately perform their function.

### Coloring Agent

A coloring agent may also be added to enhance the aesthetic nature of the spoilage reducing composition. However, a coloring agent is not necessary, and many hummingbird experts advise against it. Coloring agents include, but are not limited to dyes, pigments, and polymeric colorants. Non-limited examples of dyes include acid blue 9 dye, methylene blue, and wool violet. Examples of pigment are hematite, Cu-phthalocyanine or Ultramarine blue. Examples of polymeric colorants are various products under the Liquitint™ name produced by Milliken Chemical.

### Packaging Means

Suitable impermeable packaging means include, for example, but are not limited to containers of glass, plastic, waxed paper, and other materials known in the art for storing and dispensing liquid products. Other suitable impermeable packaging means include but are not limited to containers or film composed of glass, polyvinylchloride (PVC), cellulose, cellophane, thermoplastics, silicones, polyethylene, or polypropylene.

### EXAMPLES

For prototype testing, an inoculation medium, designated as SHF-1 was prepared by mixing the contents of several spoiled hummingbird feeders, to represent a variety of microorganisms including the black mold typical of spoiled hummingbird feeders. The term of “spoilage” as used herein means the visible appearance of microbial growth, determined by observing the nectar for turbidity, and black or white spots. The copper content of the base sugar nectar was <0.05 ppm.

### Example 1

A stock solution of sugar nectar was prepared by mixing sucrose and water in a 1:4 ratio, and stirred until completely dissolved. The water used was room temperature tap water to replicate a typical consumer preparation. 100 ml of sugar nectar was placed in transparent cups and inoculated with 5 drops of SHF-1. Varying amounts of copper sulfate 0.1% solution were added to the tubes to achieve trace concentrations ranging from 0 ppm to 50 ppm. The compositions were left at 70 degrees for four weeks.

| | Sugar | Copper | | |
|---|---|---|---|---|
| Sample | Nectar | level | Results - | |
| ID | (1:4 ratio) | (ppm) | two weeks | Results - four weeks |
| A | 100 ml | 0 | Spoiled - Cloudy | Spoiled - Cloudy, |
| | | | with white and | fibrous white mass, |
| | | | black spots | and black spots |
| B | 100 ml | 5 | Clear, no spoilage | Clear, one black |
| | | | | spot |
| C | 100 ml | 10 | Clear, no spoilage | Clear, no spoilage |
| D | 100 ml | 20 | Clear, no spoilage | Clear, no spoilage |
| E | 100 ml | 50 | Clear, no spoilage | Clear, no spoilage |

### Example 2

A stock solution of sugar nectar was prepared by mixing sucrose and tap water in a 1:4 ratio, and stirred until completely dissolved. 100 ml of sugar nectar was placed in transparent plastic tubes, and inoculated with 5 drops of SHF-1. Varying amounts of copper sulfate 0.1% solution were added to the tubes to achieve trace concentrations ranging from 0 ppm to 4 ppm, and the tubes were mixed and capped. The tubes were left outside for four weeks at ambient (seasonal range was 50-90 deg F).

| | | Sugar | | | |
|---|---|---|---|---|---|
| | | Nectar | Copper | | |
| Sample | | (1:4 | level | Results - two | Results - four |
| ID | Rep | ratio) | (ppm) | weeks | weeks |
| M | 1 | 100 ml | 0 | Spoiled - Cloudy | Spoiled - Cloudy |
| | | | | with white spots | and white spots |
| M | 2 | 100 ml | 0 | Spoiled - Cloudy | Spoiled - Cloudy |
| | | | | with black spots | with black spots |
| N | 1 | 100 ml | 2 | Clear, no spoilage | Cloudy |
| N | 2 | 100 ml | 2 | Clear, no spoilage | Clear, no spoilage |
| O | 1 | 100 ml | 4 | Clear, no spoilage | Clear, no spoilage |
| O | 2 | 100 ml | 4 | Clear, no spoilage | Clear, no spoilage |

### Example 3

A stock solution of sugar nectar was prepared by mixing sucrose and tap water in a 1:4 ratio, and stirred until completely dissolved. Sugar nectar was placed in small hummingbird feeders and inoculated with 5 drops of SHF-1. Varying amounts of copper sulfate 0.1% solution were added to the tubes to achieve trace concentrations ranging from 6 ppm to 10 ppm. The feeders tubes were left outside, used by hummingbirds and exposed to seasonal temperatures ranging from 60 to 100 deg F.

| | Sugar | | | |
|---|---|---|---|---|
| Sample | Nectar | Copper level | Results - two | Results - four |
| ID | (1:4 ratio) | (ppm) | weeks | weeks |
| X | 100 ml | 6 | Clear, no spoilage | Clear, one spot |
| Y | 100 ml | 8 | Clear, no spoilage | Clear, no spoilage |
| Z | 100 ml | 10 | Clear, no spoilage | Clear, no spoilage |

Since the natural foods consumed by hummingbirds are at 20 ppm copper or more, it is clear from these examples that transition metals such as copper are effective at naturally inhibiting microbial growth even at trace micronutrient levels.

I claim:

1. A method for preventing spoilage of sugar nectar in a nectar bird feeder, which comprises:
(i)(a) providing a nectar feeder; (b) providing sucrose sugar nectar and; (c) providing a spoilage reducing composition to said feeder, wherein said steps (a), (b), and (c) may be performed in any order or simultaneously, and said spoilage reducing composition comprises
(ii) (a) an effective amount of a transition metal salt; (b) optionally, an acidifying agent, and; (b) optionally, a functional additive.

2. The method of claim 1, wherein said transition metal salt comprises a metal salt selected from the group consisting of a copper salt, a zinc salt, an iron salt, a nickel salt, a cobalt salt, a molybdenum salt, a chromium salt, a manganese salt, a silver salt and mixtures thereof.

3. The method of claim 1, wherein said transition metal salt comprises a copper (II) sulfate.

4. A composition for preventing spoilage of sugar nectar in a nectar bird feeder, which comprises: (a) an effective amount of a transition metal salt; (b) optionally, an acidifying agent, and (b) optionally, a functional additive.

5. A composition of claim 4, wherein said transition metal salt comprises a metal salt selected from the group consisting of a copper salt, a zinc salt, an iron salt, a nickel salt, a cobalt salt, a molybdenum salt, a chromium salt, a manganese salt, a silver salt and mixtures thereof.

6. A composition of claim 4, wherein said transition metal salt comprises a copper compound selected from the group consisting of copper chloride, copper nitrate, copper citrate, copper acetate, copper carbonate, copper sulfate, copper oleate, copper hydroxide, copper sulfide, copper oxide, copper phosphate, copper gluconate, copper borate, azurite, malachite, bornite, cuprite, chalcopyrite, chalcocite, chrysocolla, and mixtures thereof.

7. A composition of claim 4, wherein said transition metal salt comprises a copper (II) sulfate.

8. A composition of claim 4, wherein said effective amount of a transition metal salt is between about 0.1 parts per million to 200 parts per million of the weight of said sugar nectar present in said nectar feeder.

9. A composition of claim 4, wherein said acidifying agent is an acid selected from the group consisting of citric acid, lactic acid, fumaric acid, ascorbic acid, carbonic acid, phosphoric acid, acetic acid, boric acid, oxalic acid, tartaric acid, and mixtures thereof.

10. A composition of claim 4, wherein said functional additive is selected from the group consisting of colorants, vitamins, spoilage indicators, anti-microbial agents, anti-molding agents, odor absorbers, flavorants, anti-caking agents, fragrances, and mixtures thereof.

11. A composition of claim 4, wherein said spoilage reducing composition occurs in a shaped body placed in the wild bird nectar feeder, wherein said shaped body comprises a form selected from the group consisting of a powder, granule, crystal, solid, gel, foam, disk, cube, cylinder, rod, ovoid, torus, sphere, donut, pyramid, prism, and combinations thereof.

12. A kit for preventing spoilage of sugar nectar in a nectar bird feeder comprising:
(i) a spoilage reducing additive composition comprising:
(a) an effective amount of a transition metal salt;
(b) optionally, an acidifying additive; and
(c) optionally, a functional additive;
(ii) optionally, sugar nectar; and
(iii) instruction means for combining said spoilage reducing composition with at least one of sugar nectar and nectar feeder.

13. The kit of claim 12, wherein said transition metal salt is comprised of a metal cation from the d-block elements of the periodic table, and an anion.

14. The kit of claim 12, wherein said transition metal salt comprises a metal salt selected from the group consisting of a copper salt, a zinc salt, an iron salt, a nickel salt, a cobalt salt, a molybdenum salt, a chromium salt, a manganese salt, a silver salt and mixtures thereof.

15. The kit of claim 12, wherein said transition metal salt comprises a copper compound selected from the group consisting of copper chloride, copper nitrate, copper citrate, copper acetate, copper carbonate, copper sulfate, copper oleate, copper hydroxide, copper sulfide, copper oxide, copper phosphate, copper gluconate, copper borate, azurite, malachite, bornite, cuprite, chalcopyrite, chalcocite, chrysocolla and mixtures thereof.

16. The kit of claim 12, wherein said transition metal salt comprises a copper (II) sulfate.

17. The kit of claim 12, wherein said effective amount of a transition metal salt is between about 0.1 parts per million to 200 parts per million of the weight of said sugar nectar present in said nectar feeder.

18. The kit of claim 12, wherein said effective amount of a transition metal salt is between about 2 parts per million to 20 parts per million of the weight of said sugar nectar present in said nectar feeder.

19. The kit of claim 12, wherein said acidifying agent is selected from the group consisting of citric acid, lactic acid, fumaric acid, ascorbic acid, carbonic acid, phosphoric acid, acetic acid, boric acid, oxalic acid, tartaric acid, and mixtures thereof.

20. The kit of claim 12, wherein the functional additive is selected from the group consisting of colorants, vitamins, spoilage indicators, anti-microbial agents, anti-molding agents, odor absorbers, flavorants, anti-caking agents, fragrances, and mixtures thereof.

21. The kit of claim 12, wherein said spoilage reducing composition is incorporated as part of the feeder.

22. The kit of claim 12, wherein said transition metal salt solution is packaged as an antimicrobial solution to treat the exterior or interior of a wild bird feeder, and optionally in a spray bottle with instructions.

23. The kit of claim 12, wherein said spoilage reducing composition occurs as a powder or concentrate to be mixed with sugar nectar and poured into the wild bird nectar feeder.

24. The kit of claim 12, wherein said spoilage reducing composition occurs pre-mixed with the sugar nectar to be mixed with water and poured directly into the wild bird nectar feeder.

25. The kit of claim 12, wherein said instructions comprise the steps selected from the group consisting of (1) the step of adding said spoilage reducing composition to said feeder in an effective amount prior to addition of said sugar nectar, (2) the step of adding said spoilage reducing composition simultaneously with said sugar nectar to said feeder, (3) the step of adding said spoiling reducing composition to said feeder in an effective amount following addition of said sugar nectar, (4) the step of mixing said spoilage reducing composition with sugar nectar prior to addition to the bird feeder, and combinations thereof.

26. The kit of claim 12, wherein said spoilage reducing composition occurs in a shaped body, as part of or placed within in the wild bird nectar feeder, wherein said shaped body comprises a form selected from the group consisting of a powder, granule, crystal, solid, gel, foam, disk, cube, cylinder, rod, ovoid, torus, sphere, donut, pyramid, prism, and combinations thereof.
